(19) United States
(12) Patent Application Publication
(10) Pub. No.: US 2024/0303458 A1
(43) Pub. Date: Sep. 12, 2024

(54) ARTICLE WITH EMBEDDED RFID LABELS AND METHODS OF MANUFACTURE THEREOF

(71) Applicants: Puneet KAPOOR, Noida, Uttar Pradesh (IN); Alok KAPOOR, Ghaziabad (IN)

(72) Inventors: Puneet KAPOOR, Noida, Uttar Pradesh (IN); Alok KAPOOR, Ghaziabad (IN)

(21) Appl. No.: 18/258,753

(22) PCT Filed: Jan. 10, 2022
(86) PCT No.: PCT/IN2022/050024

§ 371 Date: Jun. 21, 2023

(30) Foreign Application Priority Data
Jan. 10, 2021 (IN) 202011029505
May 2, 2021 (IN) 202111020086

(51) Int. Cl. G06K 19/077; G06K 19/07

(52) U.S. Cl. CPC G06K 19/07758; G06K 19/0723

(57) ABSTRACT

The present invention generally relates to articles (e.g., tubes, storage containers, rings, RNS etc.) with embedded radio frequency identification (RFID) labels and method of manufacturing the same, and more particularly relates to articles/storage containers comprising a special design of RFID labels facilitating tracking of storage container throughout its lifecycle, and facilitating reading/writing of the RFID label from one and/or all directions with single IC (Integrated Circuit). The radio frequency identification (RFID) labelled article comprising (i) an open front end, (b) a closed rear end, and (c) at least one sidewall between the open front end and the closed rear end to enclose the article, wherein the at least one sidewall comprises an embedded RFID label, and wherein the RFID label is readable in one and/or all directions and also capable of being read in bulk.

### FIELD OF THE INVENTION

The present invention generally relates to articles (e.g., tubes, storage containers, rings, RNS etc.) with embedded radio frequency identification (RFID) labels and method of manufacturing the same, and more particularly relates to articles/storage containers comprising a special design of RFID labels facilitating tracking of storage container throughout its lifecycle, and facilitating reading/writing of the RFID label from one and/or all directions with single IC (Integrated Circuit).

### OBJECT OF THE INVENTION

It is an object of the present invention to provide for an RFID Label to achieve good read/write performance in all directions in a small size.

Further, it is an object of the present invention to provide for an RFID label which can be incorporated in all kinds of surfaces including but not limited to flat and curved thin surfaces and that RFID label can withstand high temperature and pressure at the time of moulding.

It is also an object of the present invention that the RFID label should be capable of bulk reading and its reading capabilities are not got affected with the nature of the product in the container such as liquids etc. The RFID label is compatible with various thermoplastics (Polypropylene (PP), Acrylonitrile Butadiene Styrene (ABS), Polycarbonate etc.

### BACKGROUND

In the areas of medical, pharma, cosmetic and other industries it has become very important to track, trace, and identify the product or its content throughout the manufacturing and distribution life cycle. Conventionally, storage containers (e.g., tubes) are generally used for storing and dispensing liquid or pasty media in different fields of application, such as areas of food, pharmaceuticals, medical technology, and cosmetics. A plastic sample tube has been used for cryopreservation of a biological sample, and information (name, sex, age, date, sample information, lot number, etc.) is given to the side surface and lid to discriminate the contents. Information is given by writing directly on the tube with a pen or by sticking a written label to the tube. In either case, rubbing causes the ink to rub and often makes reading difficult. In addition, when the label is peeled off, not only is the information lost, but the peeled label may adhere to other tubes and the sample may be confused. The proper identification of plastic tubes are of utmost importance and other present methods include using a label, bar code or a QR code. There are limitations of using labels, bar codes and QR codes due to the line-of-sight requirement, bulk reading, and data recording/transfer (Read/Write).

To overcome the above problems, industries are moving towards RFID technology where multiple products can be read/write without the line-of-sight requirement. RFID is a technology that utilizes radio waves for data collection and transfer. There are three main types of RFID systems: low frequency (LF-100 KHz-150 Khz), high frequency (HF-13.56 MHz) and ultra-high frequency (UHF-840 MHz-960 MHz). Historically, RFID technology has been used in supply chain management, primarily to track goods in warehouses. RFID has been found to improve cost-saving measures and increase efficiency in a range of enterprises. In recent years, its usage and benefits have been explored in medical, pharma, cosmetics and several other industries. RFID has the ability to capture data automatically without human intervention that offers safety and efficiency. Thus, these industries required to integrate RFID in their present products with minimal or no change in material or design along with one another important aspect regarding process to ensure production scalability, cost-effectiveness and reliability of product. Some of the existing prior arts are discussed herein below:

In publication WO 01/029761 is described a container tracking system and a reusable container having a transponder. Here, data concerning the staging point of the container, conditions or other data of the transported articles and data for obtaining a user profile of the container can be received by and retrieved from the transponder. The description of the container itself is limited to a folding box with rectangular base measurements starting at 40×30 cm, especially for transporting foodstuffs.

DE 103 10 238 is known a container comprised of plastic having an integrated transponder that is manufactured by injection molding, the transponder lying in a plastic casing, together with which it is injected as an insert into the plastic material of the container when it is manufactured. The advantages here are the integration of the transponder in the injection-molded container, the relatively thin embodiment of the insert compared with its area, and the economical manufacture. What is not solved here, however, is the integration of the transponder in containers having curved Surfaces, the ensuring of the correct orientation of the transponder coil relative to the magnetic field of the readout device in the readout process, or the ensuring of as large a spacing as possible of the transponders of two containers touching each other or standing close together. Furthermore, in practice, the integration of such an area insert in small vessels, such as sample tubes, is difficult.

Publication DE 299 10452 U1, which relates to an apparatus and a test bottle for checking the operability of bottle inspection machines, discloses a test bottle having a transponder whose ring-shaped antenna is wound in the region of the ring groove between the reinforced rim and the head of the test bottle. Here, the antenna coil is oriented concentrically to the central bottle axis to achieve a reliable retrieval of the code also for a transceiver unit having an antenna Stationarily disposed at a small distance above the movement path of the transported test bottles. However, the range of Such an arrangement is very limited, so that the transceiver antenna must be disposed in the immediate vicinity of the antenna coil of the test bottles.

US 2010/0032437 A1 discloses that marked containers are often used for marking and ensuring the traceability of goods and the documentation of process steps in the flow of goods whether steps in production, analysis, quality assurance, transportation, delivery of goods, consumption or disposal. If transponders are to be used for this, an array of practical problems arises with regard to the optimum attachment to or integration in the container. This issue is particularly pronounced in Small, thin-walled containers, especially if they exhibit curved surfaces.

US 2011/0308335 A1 discloses a sample tube comprising an elongated body having side walls defining a top opening a closed bottom formed at the lower end of the side walls, the bottom comprising an essentially flat downside; an identification portion located at the bottom side, the identification portion comprising an opaque material with a first color and a transparent cover layer, wherein the transparent cover layer comprises a laser-sensitive filler that, upon irradiation with a laser marking beam, turns an irradiated area of the transparent cover layer into an opaque area with a second color that is contrasting from the first color. In the concept of this document, the expression “opaque’ describes the ability of the material to block a considerable amount, i.e. at least 60%, preferably more than 75%, and especially preferred more than 90%, of a laser scanning light as emitted by a bar code reader from penetrating this material. Further, the expression “transparent describes the ability of the material to let a considerable amount, i.e. at least 60%, preferably more than 75%, and especially preferred more than 90%, of a laser canning light as emitted by a bar code reader passing through this material. Additionally, the expression “filler” describes additives that preferably are equally dispersed within the plastic material of the respective parts of a sample tube as specified.

WO2007/098082 discloses that although the plastic may be transparent to electrical signals, the contents may not. By way of example, water affects the transmission of the radio frequency signals to the detector.

Thus, in the present scenario, the common methods involve attaching a RFID label with adhesive or other processes on the products or by attaching RFID tag with adhesive, snap fit, etc. The RFID tags are generally rigid, thick and expensive, and their performance drops with decrease in size. It is very difficult to incorporate rigid RFID tag in thin plastic walls. Present day methods of attaching RFID labels on the surface of plastic walls with adhesive has limitations of durability, reliability, tamper proofing. Further, with usage of adhesives, labeling itself is an extra process which may cause some difficulty in mass production with increase in rejection ratio. In some cases, labeling is not possible due to external and internal geometry.

To make full use of RFID technology, data has to be read/written at multiple stages of production. Since the performance of an RFID system is greatly affected by orientation (between reader and RFID product), metallic environment, liquid in the vicinity, and interference due to multiple RFID products in close proximity, it becomes a challenge to implement RFID in production lines.

Accordingly, there is a need to provide an improved manner of providing RFID labels/tags in articles which may be independent of orientation, and may remain functional around liquids. Additionally, there is a need for providing RFID based articles capable of being bulk read/write and can be read/write in one and/or in all directions, and further overcoming various challenges as discussed above.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

According to one embodiment of the present disclosure, a method of manufacturing an article comprising a Radio Frequency Identification (RFID) label is provided. The method comprises providing a cavity in a mould which is intended to form body of the article. Further, the method comprises providing the RFID label inside the cavity. Furthermore, the method comprises inserting a material in molten form inside the moulding to manufacture the article, thereby enclosing the RFID label within the article.

According to another embodiment of the present disclosure, a RFID labelled article is disclosed. The article comprises a front end, a rear end, and at least one sidewall between the front end and the rear end to enclose the article, wherein the at least one sidewall comprises an embedded RFID label, and wherein the RFID label is readable in all directions and also capable of being read in bulk.

According to another embodiment of the present disclosure, the article comprises an open front end, a closed rear end, and at least one sidewall between the open front end and the closed rear end to enclose the article, wherein the at least one sidewall comprises an embedded RFID label, and wherein the RFID label is readable in all directions and also capable of being read in bulk.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1A illustrates a storage container comprising RFID label in the closed rear end of the container and the reader is capable to read/write only one direction, according to prior art.

FIG. 1B illustrates a storage container comprising RFID label in the sidewall of the container and the radial direction reader, according to prior art.

FIGS. 2A and 2B illustrate exemplary architectures of the RFID label, according to an embodiment of the present invention;

FIG. 3 illustrates a storage container with a thin-walled RFID label, according to an embodiment of the present invention;

FIGS. 4A-4C respectively illustrate three possible placements of RFID labels in a sidewall of the storage container, according to various embodiments of the present invention;

FIGS. 5A-5C respectively illustrate three possible placements of RFID labels in the storage container, according to various embodiments of the present invention;

FIG. 6A illustrates a storage container with recessed portion to accommodate RFID label after first stage molding, according to an embodiment of the present invention;

FIG. 6B illustrates a storage container with RFID Label placed over recessed portion before second stage molding, according to an embodiment of the present invention;

FIG. 6C illustrates a storage container with over moulding of RFID Label placed inside the side walls over recessed portion with the help of two stage molding, according to an embodiment of the present invention;

FIGS. 6D-6E illustrate a storage container 600 with in mould labeling process to place the RFID label 606 on the outer surface of the sidewalls, according to an embodiment of the present invention;

FIGS. 6F-6H illustrate a storage container 600 with a labeling process to place the RFID label 606 on the inner surface of the sidewalls, according to an embodiment of the present invention;

FIG. 7A illustrates the placing of the RFID label at cavity of injection mould as a first stage of IML, according to an embodiment of the present invention;

FIG. 7B illustrates the RFID label becoming a part of the product at the time of the molding, according to an embodiment of the present invention;

FIG. 8A illustrates the placing of the RFID label at core pin of injection mould as a first stage of IML, according to an embodiment of the present invention;

FIG. 8B illustrates the RFID label becomes a part of the product at the time of the molding, according to an embodiment of the present invention;

FIG. 9 illustrates the placement of RFID label in thin-walled products, according to various embodiments of the present invention;

FIG. 10 illustrates an embedded RFID label configured to be read from all directions, according to an embodiment of the present invention;

FIG. 11 illustrates an embedded RFID label-based article capable of being bulk read in vicinity of liquid, according to an embodiment of the present invention; and

FIG. 12 illustrates a process flow for manufacturing of a storage container, according to an embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

RFID is an automatic identification method, relying on storing and remotely retrieving data using devices called RFID tags/labels. RFID tag/label is a product that can be applied to or incorporated into an object, animal, or person for the purpose of identification using radio frequency waves. Some tags can be read from several meters away and beyond the line of sight of the reader.

Most RFID tags/labels contain at least two parts. One is an integrated circuit for storing and processing information, modulating and demodulating a RF signal, and other specialized functions. The second is an antenna for receiving and transmitting the signal. Its non-contact, non-line-of-sight nature along with its ability to track moving objects has clearly established RFID as a superior alternative to any other identification technology available in the market. In addition to product tracking, RFID has established itself in other markets such as surveillance, livestock identification and automatic vehicle identification systems and further proliferation of this technology across a range of applications is inevitable. Developments in RFID technology continue to yield larger memory capacities, wider reading ranges, and faster processing.

The present invention utilizes RFID labels instead of RFID tags. RFID tags are not suitable for incorporated into a thin plastic material because of the reason that it has some thickness. These are also not flexible enough to wrap around the plastic products. Further, when a RFID tag is used, a need to redesign the product or even changes in material is required. Further, the use of the tag provides for reading in one direction only and the range of reding is also not very long. All such deficiencies/drawbacks are overcome by the application of RFID label, as discussed throughout this disclosure.

In various embodiments, the present invention provides for specially designed RFID labels on or in between plastic walls of a product/article (e.g., storage container) at the beginning of manufacturing process of the product/article. This technology is independent of orientation, functional around liquids, and capable of bulk reading, and is viable for a variety of products that presented challenges for the use of previous RFID technologies. Moreover, the RFID labels are compliant with high frequency (HF), ultra-high frequency (UHF) and Hybrid (HF & UHF) technologies.

Further, the present invention relates to thin-walled plastic products/articles with an integrated RFID label, and method of manufacturing the same. Specifically, the RFID label may be incorporated in a thin plastic product/article with in mould labelling (IML), over molding, or a combination of both at the time of manufacturing. The RFID label is embedded within the product/article walls, such that the label becomes a part of the product/article and tamper proof/resistant. Further, the specially designed RFID labels of the present invention may provide an enhanced performance in either one or all directions. The disclosure herein incorporates an embodiment on inserting RFID labels in the side walls of the plastic product/article (but not limited to it) to get enhanced performance and make RFID labels a part of plastic product/article without or with minimum change in the product's geometry.

Accordingly, the various embodiments of the present invention provide for numerous objectives and technical advancements of embedded RFID labels embedded in articles/storage containers, such as:
a) Embedded RFID labels are configured to achieve read/write capability from all directions in a small size;
b) Embedded RFID labels are thin and flexible so that these may be incorporated in flat and curved thin surfaces;
c) Embedded RFID labels are made up of special substrate (PET, PVC, PP, ABS, PC, Teslin, PETG & etc.) that withstand high temperature and pressure at the time of moulding;
d) Embedded RFID labels are capable of being bulk read/written on to;
e) Embedded RFID labels are configured to be read/written in the vicinity of liquids, i.e., within the storage containers/articles comprising liquids;
f) Embedded RFID labels are compatible with various thermoplastics (polypropylene (PP), acrylonitrile butadiene styrene (ABS), polycarbonate etc.); and
g) Thickness of embedded RFID labels should be below 0.2 mm for easy incorporation.

Using the RFID labels, a lifecycle tracking of storage containers or the products they are embedded in, may be performed. This further facilitates tracking an original or a deceptively similar counterfeit. Further, the RFID label-based tracking may facilitate in confirming if the storage container has been stored and/or transported properly.

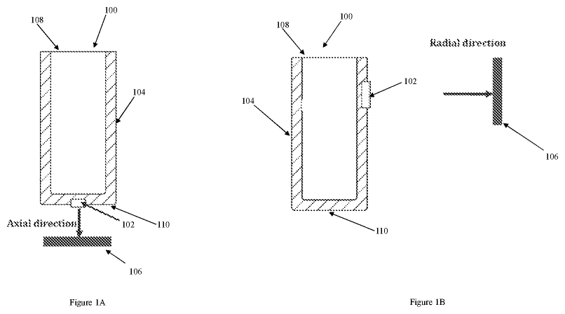

FIG. 1A illustrates a storage container 100 comprising RFID label in the closed rear end of the container, according to prior art and the reader is capable to read/write only one direction. As depicted, the storage container 100 may include a sidewall 104, an open front end 108, and a closed rear end 110. In the current exemplary storage container, the RFID label 102 may be included on the outer surface of the closed rear end 110 of the storage container 100. Further, an RFID reader 106 may be capable of reading/writing the RFID label 102 only in one direction, as per prior art solutions.

FIG. 1B illustrates a storage container 100 comprising RFID label 102 on the outer surface of the sidewall of the container and the radial direction reader, according to prior art. As depicted, the storage container 100 may include a sidewall 104, an open front end 108, and a closed rear end 110. In the current exemplary storage container, the RFID label 102 may be included on the outer surface of the sidewall 104 of the storage container 100. Further, an RFID reader 106 may be capable of reading/writing on the RFID label 102 only in one direction, as per prior art solutions.

The embodiments of the present invention preferably use RFID labels in ultra-high frequency (UHF) range. The UHF labels are preferable over low frequency (LF) and high frequency (HF) labels, since the UHF labels are preferred for the purpose of thin-walled embedding which may be read/written from all directions and are capable of being bulk read. The present invention provides the below experimental data and findings to clarify the preference of UHF labels over LF and HF labels.

### Low Frequency Labels

LF RFID systems operate at 125 KHz, although there are some that operate at 134 KHz. This frequency band provides a limited read range from few centimeters or inches, and has slower read speed than the higher frequencies.

The features of low frequency RFID labels are provided herein below:
1. Size—16×8.50 mm
2. Thickness—1 mm (Not suitable for thin wall plastic products)
3. Flexibility—Not flexible
4. Bulk Reading—Not possible
5. Reading in all direction/orientation—Not possible
6. Temperature—This label cannot withstand with high temperature
7. High Pressure—They cannot stand with high pressure of molding process
8. High read/write distance—Low
9. Change in dimensions and material—Yes requires major changes
10. Reading in vicinity of Liquid—Yes
11. Fully enclosed & tamper proof—No

### High Frequency Labels

High Frequency labels operate at 13.56 MHz frequency band with read ranges between 10 cm and 1 m. Since the label is thin and flexible and can be read in multiples also, but it can only be used when read/write performance is required only in single direction. It is majorly used when near field communication application is required. The features of high frequency RFID labels are provided herein below:
1. Size—16×8.50 mm
2. Thickness—0.1 mm
3. Flexibility—Yes
4. Bulk Reading—Can read multiple but not suitable for this application. Create problem when stacked.
5. Reading in all direction/orientation—Not possible, Optimum performance can achieved only in one direction.
6. Temperature—This label can withstand with high temperature
7. High Pressure—Yes it can bear high pressure of molding process
8. High read/write distance—Moderate
9. Change in dimensions and material—No
10. Reading in vicinity of Liquid—No
11. Fully enclosed & tamper proof—Yes possible

Using High Frequency Labels is not an optimum solution due to optimum read/write is possible in one direction. HF labels are suitable for near field communication (NFC) applications.

### UHF Labels

Generally, UHF antenna has a small loop and bigger dipoles. Dipoles gives enhanced performance in one direction but in the present invention, the specially designed RFID labels have an antenna having a bigger loop with dimensions up to 20 mm×10 mm and having a dipole up to 10 mm or no dipole to achieve good performance and read range in all directions. UHF label antenna types are typically dipole-shaped. Mostly linear polarized antenna (meaning of polarization is the direction in which the electric field of a radio wave oscillates while it propagates through a medium). Due to this, it provides better reading when the label is in same plane, and user gets great variation in reading the label when moved in other plane/directions/angles.

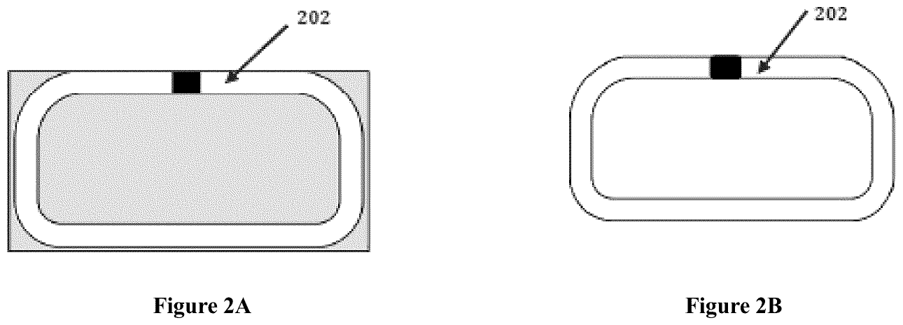

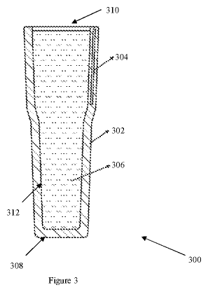

Further, the present invention utilizes a UHF label for desired application. In the specially designed UHF RFID label used in present invention, the specially designed antenna having bigger loop and very small or no dipole achieves good performance and read/write range in all directions. Further, the present invention utilizes a small size RFID antenna which can collect more power to activate IC for further communication with reader. The features of high frequency RFID labels used in the present invention are provided herein below:
1. Size—16×8.50 mm
2. Thickness—0.10 mm (very good for thin-walled plastic products)
3. Flexibility—Yes (can be incorporated within thin walled)
4. Bulk Reading—Yes possible
5. Reading in all direction/orientation—Yes possible
6. Temperature—This label can withstand with high temperature
7. High Pressure—Yes it can bear high pressure of molding process
8. High read/write distance—Yes
9. Change in dimensions and material—No or very minimum change is required
10. Reading in vicinity of Liquid—Yes, with the help of our specially designed antenna
11. Fully enclosed & tamper proof—Yes possible
12. 360° reading possible ≥300 mm
   FIGS. 2A and 2B illustrate exemplary architectures of the RFID label 202, according to an embodiment of the present invention. In one exemplary embodiment, one RFID label comprising IC, antenna & substrate and another comprising IC and closed looped antenna only to incorporate RFID label in ultra-thin plastic walls and the dimensions of both RFID labels may be:
Length: 15.5 mm+/−5 mm
Width: 8.5 mm+/−5 mm

It may be apparent to a person skilled in the art that the previously known RFID labels have a small loop and a large size dipole, but the special designed RFID label has bigger loop and no or small dipole.

FIG. 3 illustrates a storage container 300 with a thin wall up to 3 mm comprising RFID label, according to an embodiment of the present invention. The storage container 300 may be, for example, but not limited to, a plastic tube e. In one embodiment, the storage container 300 may include a thin sidewall 302, a RFID label 304, and liquid 306. Further, the storage container 300 may include a cylindrical container body 312 surrounded by the sidewall 302. Also, the storage container 300 may include a closed lower end 308 and an open upper end 310. The RFID label 304 may be arranged inside the container body 312 and may be recorded with individual identification information that may be read by a wireless communication (RFID) reader from the outside in axial or radial direction.

In an embodiment of the present invention, the RFID label 304 may be configured to exchange information in a contactless manner with a read and or read/write device outside of the storage container 300. This exchanged information may relate to the storage container 300 itself or to the product contained in the storage container 300, but not limiting to, name, sex, age, date, sample information, lot number, etc. Since the RFID label 304 component is set in the mass of the plastic material (in case of plastic tube as storage container 300) forming the tube body, it may be used in an early stage of the production and be used for monitoring the production of the tube. The RFID label 304 is embedded within the storage container 300, preferably without the use of adhesive materials, for example, during injection molding of the body. Once the tube has been produced and delivered to the packager, the RFID label may also be used to enable the packaged product to be traced including the data for the origin of its components, conditions of production, storage before first opening, etc.

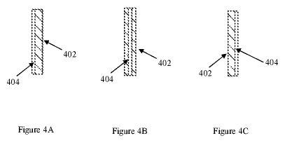

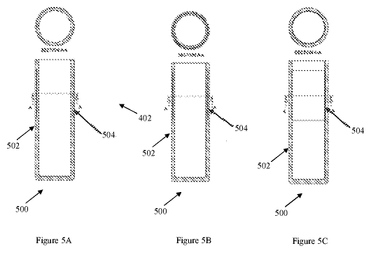

FIGS. 4A-4C respectively illustrate three possible placements of RFID labels in a sidewall of the storage container, according to various embodiments of the present invention. In one embodiment, the RFID label 404 may be embedded on the inner surface of the sidewall 402 of the storage container, as illustrated in FIG. 4A. In another embodiment, the RFID label 404 may be embedded completely inside the sidewall 402 of the storage container, as illustrated in FIG. 4B. In yet another embodiment, the RFID label 404 may be embedded on the outer surface of the sidewall 402 of the storage container, as illustrated in FIG. 4C.

To incorporate RFID label in side walls of the plastic tube in three ways:
A. RFID label on outer surface of the side wall as shown in FIG. 4C
B. RFID label totally inside the side walls (Plastic on both sides of RFID label as shown in FIGS. 3 and 4B.
C. RFID label on the inside wall of the tube as shown in FIG. 4A.

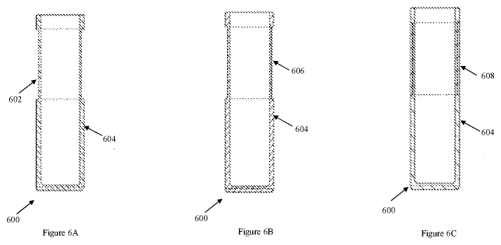

FIGS. 5A-5C respectively illustrate three possible placements of RFID labels in the storage container, according to various embodiments of the present invention. In one embodiment, the RFID label 504 may be embedded on the outer surface of the sidewall 502 of the storage container 500, as illustrated in FIG. 5A. In another embodiment, the RFID label 504 may be embedded completely inside the sidewall 502 of the storage container 500, as illustrated in FIG. 5B. Specifically, the RFID label 504 may be embedded or sandwiched between the two plastic material layers of the sidewall. In yet another embodiment, the RFID label 504 may be embedded on the inner surface of the sidewall 502 of the storage container 500, as illustrated in FIG. 5C.

The RFID label is embedded within the storage container 500, preferably without the use of adhesive materials, for example, during injection molding of the body. The conditions for placing the RFID label 504 in the cavity of the injection mold are dependent on the chosen shape of the antenna. In an embodiment, there is also disclosed a method for producing such storage container 500 (e.g., tube body) characterized in that an RFID label 504 is used, which is capable of exchanging, without physical contact, information with a read and/or a read/write device, and is placed inside the cavity of the mold intended to form the body, and subsequently, the body is completely molded, with the plastic material in molten form flowing in, so that the plastic material encloses the RFID label 504, thus making the body and RFID label inseparable and thereby forming a tamper proof RFID enabled articles.

The plastic material is preferably injection molded in the cavity of the mold. In another embodiment, compression molding or blow molding can also be performed if the electronic/RFID components used are solid enough to be capable of resisting the mechanical stresses caused by this type of formation. Regardless of whether the molding is performed by injection or by compression or by blowing, the RFID label 504 is deposited into the cavity of the mold intended to form the body of the storage container 500. The disclosure herein incorporates various embodiments of inserting RFID label 504 inside or on the side walls of the storage container (but not limited to it) to enhance performance and make RFID label 504 a part of the storage container 500 without disturbing the geometry of the storage container 500.

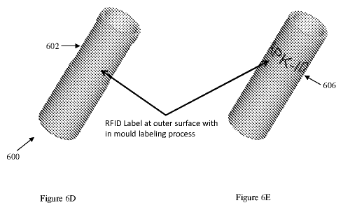

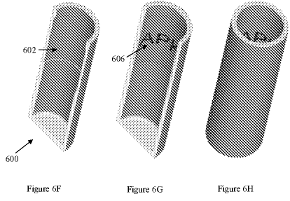

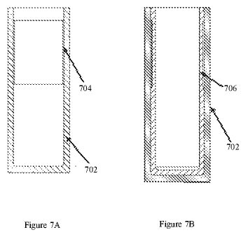

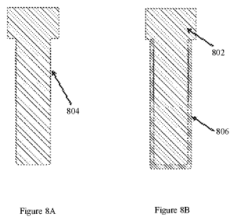

FIG. 6A illustrates a storage container 600 with a recessed portion to accommodate a RFID label after first stage molding, according to an embodiment of the present invention. In the embodiment illustrated in FIGS. 6A-6C, the RFID label is embedded inside the side walls of the storage container 600. The moulding process for embedding the RFID label inside the sidewalls is a two-stage process. In an embodiment, the storage container 600 may at least include a sidewall 604. The sidewall 604 may further include a recessed area 602 where a RFID label may be placed. The process of in-mould labeling (IML) of RFID label in the storage container 600 (e.g., plastic tube) includes a presence of recess area 602 on the storage container 600's body for accommodating the RFID label.

FIG. 6B illustrates a storage container 600 with RFID label 606 placed over recessed portion before second stage molding, according to an embodiment of the present invention. As depicted, the RFID label 606 may be placed inside the recess area 602 of the storage container 600. In such process, the RFID label is inserted in the mould in the cavity side using robots and vacuum, and the label becomes a part of the product at the time of injection moulding.

FIG. 6C illustrates a storage container 600 with over moulding 608 of RFID label 606 placed inside the side walls over recessed portion with the help of two stage molding, according to an embodiment of the present invention. Two Stage molding is a unique injection molding process that results in a seamless combination of RFID label 606 and materials (e.g., plastic material) into a single part or product. For RFID, however, the sensitive electronics are protected by a melt-flow system specially conceived for this purpose. For labels to be completely integrated into plastic, the process becomes two-staged.

FIGS. 6D-6E illustrate a storage container 600 with an in-mould labeling process to place the RFID label 606 on the outer surface of the sidewalls, according to an embodiment of the present invention. The storage container depicts a recess 602, where an RFID label 606 may be embedded using in-mould labeling techniques.

FIGS. 6F-6H illustrate a storage container 600 with a labeling process to place the RFID label 606 on the inner surface of the sidewalls, according to an embodiment of the present invention. In this embodiment, the RFID label 606 will be moulded on the recess inside the body of the storage container in a single stage process, which includes placing the label over the recess portion, and thereby over-moulding the storage container material (e.g., molten plastic) on the RFID label 606. The RFID label 606 will be placed on the punch using Robots/Vacuum and at the time of moulding, the label will become a part of the inner surface. In all the above processes, the antenna design is very critical which can be incorporated on the side wall and still give good performance in the axial area in radial direction.

Thus, the three different embodiments of embedding the RFID labels in the article/product/storage container are provided herein below:

### Rfid Label on the Outer Surface

The specially designed RFID Label in terms of antenna design, chip and material can be incorporated on the outer surface of thin plastic walls with IML. This RFID Label can be inserted in the cavity of the mold by a robot and held in place by a special mold design incorporating vacuum or electrostatic technologies. The RFID Label becomes a part of the product at the time of the molding, as illustrated in FIGS. 6D-6E.

The special process can insert, hold and mold small RFID labels on flat, curved or circular thin surfaces. The present invention illustrates the incorporation of a small RFID Label with enhanced read/write performance on the outer surface of thin plastic components.

Rfid Embedded within the Wall

In another embodiment, the special RFID Label will be fully encapsulated within the thin wall by a two-stage molding process. For first stage molding, the RFID Label will be inserted on the cavity of the mold by a robot, held in place by a special mold design incorporating vacuum or electrostatic technologies and molded by IML Technology. In the second stage, the plastic material is provided in molten form over the RFID Label (overmold) and completely cover the RFID Label, resulting in a fully encapsulated, tamper proof product. In some applications, instead of using IML for the first stage, the part can be molded and overmolded (second stage) to get the final product, as depicted in FIGS. 6A-6C. Both processes have their merits—the specific process is chosen according to the product being manufactured.

### Rfid Label in the Inner Surface of the Plastic Product

The specially designed RFID Label in terms of antenna design, chip and material can be incorporated on the inner surface of thin plastic walls with IML. This RFID Label can be inserted on the punch of the mold by a robot and held in place by a special mold design incorporating vacuum or electrostatic technologies. The RFID Label becomes a part of the product at the time of the molding, as depicted in FIGS. 6F-6H.

The unique process can insert, hold and mold small RFID Labels on flat, curved or circular thin surfaces. We show, for the first time, the incorporation of a small RFID Label with enhanced read/write performance on the inner surface of thin plastic components.

In all the above processes, the RFID Label design is proven to be very critical as it can be incorporated in the side wall and still give good performance in either one or all directions with an additional capability to be read in bulk.

The design of special RFID Label is capable of working with UHF-global frequency (840-960 MHz). The design of special RFID Label is capable of working with high frequency—13.56 MHz (10-30 MHz). The design of special RFID Label is capable of working with Hybrid technology UHF+HF-global frequency (840-960 MHz) & HF-13.56 MHz (10-30 MHz).

FIG. 7A illustrates the placing of the RFID label at cavity of injection mould as a first stage of IML, according to an embodiment of the present invention. 704 depicts RFID label inside the mould cavity. 702 depicts the mould cavity.

FIG. 7B illustrates the RFID label becoming a part of the product at the time of the molding, according to an embodiment of the present invention. 706 depicts the product.

FIG. 8A illustrates the placing of the RFID label at core pin of injection mould as a first stage of IML, according to an embodiment of the present invention. 802 depicts a core pin. 804 depicts RFID label placed on the core pin/punch. 806 depicts product.

FIG. 8B illustrates the RFID label becomes a part of the product at the time of the molding, according to an embodiment of the present invention;

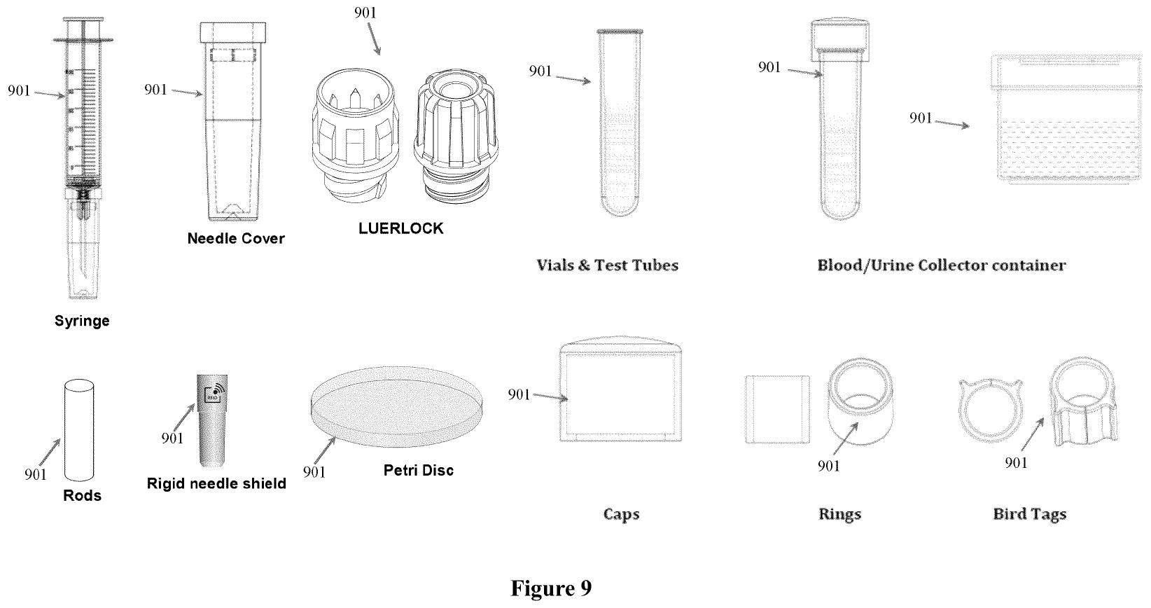

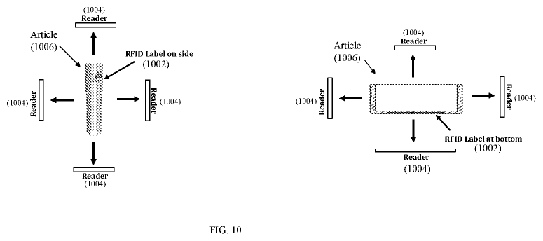

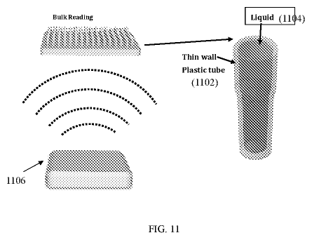

FIG. 9 illustrates the placement of RFID label in thin-walled products, according to various embodiments of the present invention. The exemplary products where the RFID label may be included include, but not limited to, syringes, needle cover, vials and test tubes, blood/urine collector container, caps, rings, RNS, Rod and bird ring. The RFID labels may be incorporated within the thin sidewalls of each of these exemplary containers.

FIG. 10 illustrates an embedded RFID label 1002 configured to be read from all directions, according to an embodiment of the present invention. In one embodiment, the RFID label 1002 may be read using a RFID reader 1004 from one or more directions. As depicted, the RFID reader 1004 may be deployed from any of four directions to read the RFID label 1002. However, it may be apparent to a person skilled in the art that the four directions are only shown for illustrative purposes and the RFID reader 1004 may be deployed in any of the 360 degrees directions around the article 1006 to read the data from RFID label 1002.

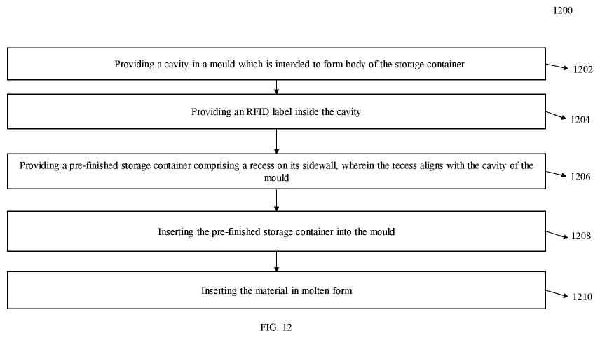

FIG. 11 illustrates an embedded RFID label-based article or storage container 1102 capable of being bulk read (with other RFID labels) in vicinity of liquid, according to an embodiment of the present invention. In one embodiment, the article or storage container 1102 may be a thin walled plastic tube which may include liquid 1104. The RFID label (not shown) is embedded in the walls of the article 1102 and is capable of being bulk read along with other labels using a reader 1106. As illustrated throughout the disclosure, the RFID label is preferably a UHF label with a specially designed antenna having a bigger loop and very small or no dipole.

FIG. 12 illustrates a process flow depicting a method 1200 for manufacturing of an article/storage container, according to an embodiment of the present invention.

At step 1202, the method 1200 comprises providing a cavity in a mould which is intended to form body of the article/storage container. The mould may be in the form of article/container which is currently being manufactured.

At step 1204, the method 1200 comprises providing the RFID label inside the cavity. In one embodiment, the RFID label to be inserted within the thin sidewall may be provided within the cavity of the mould. In other embodiments, the cavity may be provided within the mould in a manner corresponding to the intended location of RFID label within the article/storage container. For example, the cavity may be provided for inserting the RFID label within the thin sidewall, or on the outer surface of the thin sidewall, or on inside surface of thin sidewall.

At step 1206, the method 1200 comprises providing a pre-finished article/storage container comprising a recess on its sidewall, wherein the recess aligns with the cavity of the mould.

At step 1208, the method 1200 comprises inserting the pre-finished article/storage container into the mould.

At step 1210, the method 1200 comprises inserting the material in molten form to completely prepare the article/storage container.

The present invention provides various technical advancements over the background or current state of the art in the domain of storage containers with/without RFID labels. Some of the technical advancements are illustrated herein below:
i. RFID labels can be incorporated in thin walls.
ii. The special design/shape of RFID labels can be incorporated in curved, circular and other shapes.
iii. The insertion of RFID labels during the manufacturing process of storage containers requires no or minimal change in existing product design of the containers.
iv. The insertion of RFID labels during the manufacturing process of storage containers requires no or minimal change in existing product material of storage containers.
v. With the special design of RFID labels, the reading of labels is possible through all directions.
vi. With the reading of RFID labels possible through all directions, the bulk reading of storage containers may be efficiently performed.
vii. The insertion of RFID labels during the manufacturing process of storage containers in the sidewalls facilitates high performance even in the vicinity of liquid inside the storage containers.
viii. The RFID labels can be incorporated in very small parts.
ix. The insertion of RFID labels inside the storage containers using molding techniques is a very cost-effective solution.
x. The process of insertion of RFID labels may be fully automated, and requires minimal or zero manual intervention.
xi. With the embedding of RFID labels inside the sidewalls, the RFID labels will not touch the contents in the storage containers.

Additionally, the present invention provides for additional technical advancements, such as:
(1) Incorporating RFID label on the outside of thin plastic wall (Flat, curve, circular, oval or any other shape) with IML.
(2) Incorporating RFID label on the inside of thin plastic wall (Flat, curve, circular, oval or any other shape) with IML.
(3) Incorporating RFID label within the thin plastic wall with a combination of IML, moulding, and over moulding.
(4) Incorporating RFID label within thin plastic wall by 1st moulding, label application (adhesive or other process) and 2nd stage over moulding.
(5) Design of special RFID label in terms of a special antenna+Chip, design and material suitable for in-mould labeling.
(6) Design of special RFID label that can give enhanced performance up to 350 mm read range in one direction.
(7) Design of special RFID label that can give enhanced performance (up to 200 mm) with read range in all directions with a very small RFID Label (eg: 8×16 mm).
(8) Design of special RFID label in terms of Antenna+Chip Design suitable for bulk reading in the vicinity of liquids.
(9) Design of special RFID label with minimum substrate material for ultra-thin plastic product (i.e., ≤0.7 mm)
(10) Design of special RFID label working with UHF—global frequency (840-960 MHz) (11) Design of special RFID label working with high frequency—13.56 MHz (10-30 MHz)
(12) Design of special RFID label working with Hybrid technology UHF+HF—global frequency (840-960 MHz) & HF—13.56 MHz (10-30 MHz).

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A radio frequency identification (RFID) labelled article comprising:
a front end;
a rear end; and
at least one sidewall between the front end and the rear end, wherein the at least one sidewall comprises a flexibly embedded RFID label.

2. The RFID labelled article as claimed in claim 1, wherein the RFID label is embedded within the article using in-mould labelling, over moulding, or a combination of both.

3. The RFID labelled article as claimed in claim 1, wherein the article is a rigid needle shield (RNS), a luer lock tip closure, a syringe, a tube, a storage container, a ring, or a bird ring.

4. The RFID labelled article as claimed in claim 1, wherein the RFID label is placed either on an inner surface of the at least one sidewall, on an outer surface of the at least one sidewall or between the inner surface of the at least one sidewall and the outer surface of the at least one sidewall.

5. The RFID labelled article as claimed in claim 1, wherein the thickness of the at least one sidewall is between 0.2 mm and 3 mm.

6. The RFID labelled article as claimed in claim 1, wherein the RFID label is readable in one or more directions and the RFID label comprises an antenna having an area up to 1000 sq·mm.

7. A method of manufacturing an article comprising a radio frequency identification (RFID) label, the method comprising:
providing a cavity in a mould which is intended to form the body of the article;
providing the RFID label inside the cavity; and
inserting a material in molten form into the mould to manufacture the article, thereby embedding the RFID label in the article.

8. The method as claimed in claim 7, wherein the material is a thermoplastic.

9. The method as claimed in claim 7, wherein the method is performed using injection moulding, compression moulding, or blow moulding.

10. The method as claimed in claim 7, wherein providing the RFID label inside the cavity comprises providing the RFID label on an outer surface of a sidewall of the article, on an inner surface of a sidewall of the article, or completely inside a sidewall of the article.

11. The method as claimed in claim 7, comprising:
providing a pre-finished article comprising a recess in a sidewall of the article, wherein the recess aligns with the cavity of the mould; and
inserting the pre-finished article into the mould such that the RFID label is embedded in the recess through the cavity.

12. The method as claimed in claim 7, wherein the article is a rigid needle shield (RNS), a luer lock tip closure, a syringe, a tube, a storage container, a ring, or a bird ring.

13. A radio frequency identification (RFID) labelled article comprising:
a moulded plastic;
at least one sidewall; and
an RFID label flexibly embedded in the moulded plastic, wherein the RFID label comprises an antenna and an integrated circuit.

14. The RFID labelled article as claimed in claim 13, wherein the article is a rigid needle shield (RNS), a luer lock tip closure, a syringe, a tube, a storage container, a ring, or a bird ring.
